(19) United States
(12) Patent Application Publication
(10) Pub. No.: US 2026/0270682 A1
(43) Pub. Date: Sep. 10, 2026

(54) METHOD FOR DETERMINING AI MODEL, AND COMMUNICATION DEVICE AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/877,022

(22) PCT Filed: Jun. 23, 2022
(86) PCT No.: PCT/CN2022/100906

§ 371 Date: Dec. 19, 2024

(51) Int. Cl. H04W 8/24; H04W 24/10

(52) U.S. Cl. CPC H04W 8/24; H04W 24/10

(57) ABSTRACT

A method for determining an AI model is provided. The method is performed by UE, and includes: sending AI capability information of the UE, wherein the AI capability information is used for a base station to determine an AI model for CSI used by the UE, wherein the AI capability information includes at least one of AI capability indication information, AI level indication information, identification information of the AI model, identification information of an AI platform, AI inference indication information or AI training indication information.

### CROSS REFERENCE TO RELATED APPLICATIONS

The present disclosure is the U.S. national phase application of International Application No. PCT/CN2022/100906 filed on Jun. 23, 2022, the content of which is incorporated herein by reference in its entirety for all purposes.

### TECHNICAL FIELD

The present disclosure relates to, but is not limited to, the field of wireless communication technology, in particular, to a method and an apparatus for determining an AI model, a communication device, and a storage medium.

### BACKGROUND

The Artificial Intelligence (AI) technology can currently be used to improve the performance of an air interface. For example, the AI technology can be used to reduce the cost of the Channel State Information (CSI) feedback and improving the accuracy of the channel estimation.

### SUMMARY

According to a first aspect of the present disclosure, a method for determining an AI model is provided. The method is performed by UE, and includes:
sending Artificial Intelligence (AI) capability information of the UE, wherein the AI capability information is configured for a base station to determine an AI model for Channel State Information (CSI) used by the UE, and wherein the AI capability information includes at least one of:
AI capability indication information configured to indicate whether the UE supports an AI capability;
AI level indication information configured to indicate a level of the AI capability supported by the UE;
identification information of the AI model configured to indicate the AI model supported by the UE;
identification information of an AI platform configured to indicate the AI platform supported by the UE;
AI inference indication information configured to indicate whether the UE supports an AI inference capability; or
AI training indication information configured to indicate whether the UE supports a training capability of the AI model.

According to a second aspect of the present disclosure, a method for determining an AI model is provided. The method is performed by a base station, and includes:
receiving Artificial Intelligence (AI) capability information of user equipment (UE); and determining, based on the AI capability information, at least one AI model for Channel State Information (CSI) used by the UE;
wherein the AI capability information includes at least one of:
AI capability indication information configured to indicate whether the UE supports an AI capability;
AI level indication information configured to indicate a level of the AI capability supported by the UE;
identification information of the AI model configured to indicate the AI model supported by the UE;
identification information of an AI platform configured to indicate the AI platform supported by the UE;
AI inference indication information configured to indicate whether the UE supports an AI inference capability; or
AI training indication information configured to indicate whether the UE supports a training capability of the AI model.

According to a third aspect of the present disclosure, a communication device is provided.

The communication device includes:
a processor; and
a memory for storing executable instructions for the processor;
wherein the processor is configured to run the executable instructions to cause the method for determining the AI model described in any embodiment of the present disclosure to be implemented.

According to a fourth aspect of the present disclosure, a computer storage medium is provided, which stores a computer executable program. When the computer executable program is executed by a processor, the method for determining the AI model described in any embodiment of the present disclosure is caused to be implemented.

It should be understood that the general description in the above and the detailed description in the following are only exemplary and explanatory, and cannot limit embodiments of the present disclosure.

### BRIEF DESCRIPTION OF THE DRAWINGS

FIG. 1 is a schematic diagram of a structure of a wireless communication system according to one or more embodiments of the present disclosure;

FIG. 2 is a schematic diagram of a method for determining an AI model according to one or more embodiments of the present disclosure;

FIG. 3 is a schematic diagram of a method for determining an AI model according to one or more embodiments of the present disclosure;

FIG. 4 is a schematic diagram of a method for determining an AI model according to one or more embodiments of the present disclosure;

FIG. 5 is a schematic diagram of a method for determining an AI model according to one or more embodiments of the present disclosure;

FIG. 6 is a schematic diagram of a method for determining an AI model according to one or more embodiments of the present disclosure;

FIG. 7 is a block diagram of an apparatus for determining an AI model according to one or more embodiments of the present disclosure;

FIG. 8 is a block diagram of an apparatus for determining an AI model according to one or more embodiments of the present disclosure;

FIG. 9 is a block diagram of user equipment according to one or more embodiments of the present disclosure; and

FIG. 10 is a block diagram of a base station according to one or more embodiments of the present disclosure.

### DETAILED DESCRIPTION

Detailed explanations of exemplary embodiments will be provided herein, with examples being illustrated in the drawings. The same reference numerals in different drawings represent the same or similar elements when the following description refers to the drawings, unless otherwise indicated. The implementations described in the following exemplary embodiments do not represent all implementations consistent with the present disclosure, instead, they are only examples of devices and methods consistent with some aspects of embodiments of the present disclosure as described in the appended claims.

The terms used in embodiments of the present disclosure are for the purpose of description of specific embodiments only, and are not intended to limit the embodiments of the present disclosure. Singular forms such as “a” and “the” used in the present disclosure and the appended claims are also intended to include plural forms, unless other meanings are clearly indicated in the context. It should also be understood that the term “and/or” used in the present disclosure refers to and includes any or all possible combinations of one or more listed items related.

It should be understood that although terms such as first, second, and third may be used to describe various information in embodiments of the present disclosure, such information should not be limited to these terms, which are only used to distinguish information of the same type from each other. For example, without departing from the scope of the present disclosure, the first information can also be referred to as the second information, and similarly, the second information can also be referred to as the first information. The word “if”′ used herein can be interpreted as “when” or “while” or “in response to determination that”, depending on the context.

Reference is made to FIG. 1, which illustrates a schematic diagram of a structure of a wireless communication system provided by embodiments of the present disclosure. As shown in FIG. 1, the wireless communication system is a communication system based on cellular mobile communication technology, which can include several user equipment 110 and several base stations 120.

The user equipment 110 can be equipment that provides voice and/or data connectivity to a user. The user equipment 110 can communicate with one or more core networks via a Radio Access Network (RAN). The user equipment 110 can be an IoT (Internet of Things) terminal, for example, a sensor device, a mobile phone (or a “cellular” phone), and a computer with IoT terminals, such as fixed, portable, pocket, handheld, computer built-in, or vehicle mounted devices. For example, stations (STA), subscriber units, subscriber stations, mobile stations, mobiles, remote stations, access points, remote terminals, access terminals, user terminals, user agents, user devices or user side devices. Alternatively, the user equipment 110 can also be a device for unmanned aerial vehicles. Alternatively, the user equipment 110 can also be an onboard device, such as a trip computer with wireless communication ability or wireless communication devices connected to an external trip computer. Alternatively, the user equipment 110 can also be a roadside device, such as a street light, a signal light, or other roadside devices with wireless communication ability.

The base station 120 can be a network side device in the wireless communication system. The wireless communication system can be the 4th generation (4G) mobile communication system, also known as Long Term Evolution (LTE) system. Alternatively, the wireless communication system can also be the 5th generation (5G) system, also known as New Radio system or 5G NR system. Alternatively, the wireless communication system can also be the next generation system following 5G system. The access network in 5G system can be referred to as the New Generation-Radio Access Network (NG-RAN).

The base station 120 can be the Evolved Node B (eNB) employed in 4G system. Alternatively, the base station 120 can also be the next Generation Node B (gNB) constructed in a centralized and distributed architecture in 5G system. When constructed in the centralized and distributed architecture, the base station 120 usually includes a central unit (CU) and at least two distributed units (DUs). The central unit is provided with a protocol stack consisting of the Packet Data Convergence Protocol (PDCP) layer, the Radio Link Control (RLC) layer, and the Medium Access Control (MAC) layer. The distributed unit is provided with a protocol stack of the Physical (PHY) layer. Specific implementations of the base station 120 are not limited in embodiments of the present disclosure.

A wireless connection can be established between the base station 120 and the user equipment 110 via a wireless air interface. In different implementations, the wireless air interface is based on the 4th generation (4G) mobile communication network technology standard. Alternatively, the wireless air interface is based on the 5th generation (5G) mobile communication network technology standard, for example, the wireless air interface is the New Radio. Alternatively, the wireless air interface can also be a wireless air interface based on the next generation mobile communication network technology standard following 5G.

In some embodiments, the E2E (End to End) connection can also be established between user equipment 110. For example, in the Vehicle to Everything (V2X) communication, there are scenes such as V2V (Vehicle to Vehicle) communication, V2I (Vehicle to Infrastructure) communication, and V2P (Vehicle to Pedestrian) communication.

In some embodiments, the above-mentioned user equipment can be considered as the terminal devices in the following embodiments.

Some of the base stations 120 are respectively connected to the network management device 130. The network management device 130 can be a core network device in the wireless communication system, for example, the network management device 130 can be the Mobility Management Entity (MME) in the Evolved Packet Core (EPC). Alternatively, the network management device can also be other core network devices, such as the Service GateWay (SGW), the Public Data Network GateWay (PGW), the Policy and Charging Rules Function (PCRF), or the Home Subscriber Server (HSS), etc. Implementations of the network management device 130 are not limited in embodiments of the present disclosure.

For the convenience of those skilled in the art to understand the present disclosure, one or more embodiments are described in the present disclosure to clearly illustrate the technical solutions of the present disclosure. Those skilled in the art can understand that one or more embodiments provided in the present disclosure can be implemented separately, combined with methods of other embodiments in the present disclosure, or implemented separately or in combination with some methods in other related art, and the present disclosure does not limit this.

An explanation for the related art will be first provided, for better understanding the technical solutions described in any of embodiments of the present disclosure.

The mainstream approach for the CSI feedback is to adopt a “two-sided” AI structure, where an AI based CSI compression encoder is located on the user equipment (UE) side, the UE compressing the measured CSI based on the AI based CSI compression encoder and sending the compressed CSI information to the base station, and an AI based CSI decompression encoder is located on the base station side, the base station decompressing and restoring the compressed CSI information sent by the UE by using the AI based CSI decompression encoder corresponding to the AI based CSI compression encoder. Compression and decompression, appearing in pairs, are two parts of an AI model, and thus it is necessary to ensure that the AI model used by the UE and the AI model used by the base station have common understanding.

For the AI model that can only be implemented on both the UE and base station sides for CSI compression, if the AI model is issued by the base station to the UE or reported by the UE to the base station, it is necessary to interact AI models between the UE and the base station, resulting in increased signaling and power consumption.

In some embodiments, the complexity of an AI soft implementation is much higher than the complexity of an AI hard implementation. The AI soft implementation can build some basic models in a chip, some parameters of the basic models can be changed by the base station, and the models are then improved on the UE side through C language. The AI hard implementation can be achieved by directly embedding AI models into the chip, and the AI models can be embedded into the chip by solidifying the AI models in hardware using Verilog language.

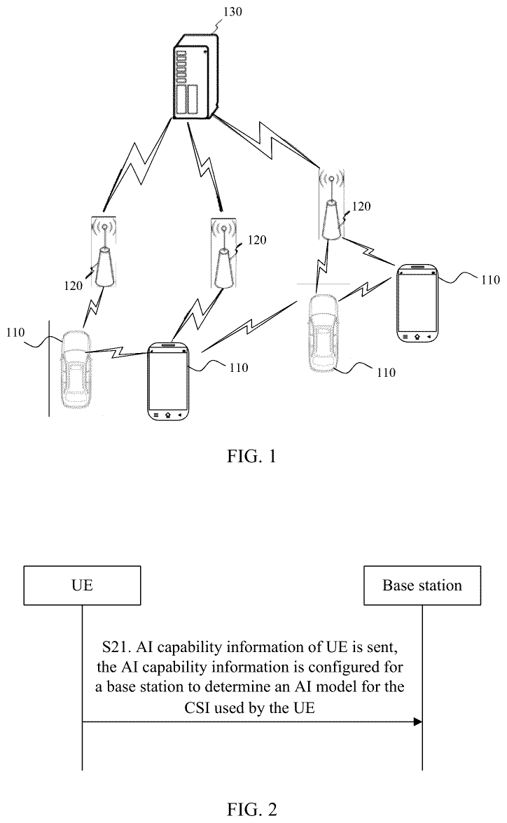

As shown in FIG. 2, embodiments of the present disclosure provide a method for determining an AI model. The method is performed by UE, and includes following steps.

In step S21, AI capability information of UE is sent. In some embodiments, the AI capability information is configured for a base station to determine an AI model for CSI used by the UE.

In some embodiments, the AI capability information includes at least one of the following: AI capability indication information configured to indicate whether the UE supports an AI capability;
AI level indication information configured to indicate a level of the AI capability supported by the UE;
identification information of an AI model configured to indicate an AI model supported by the UE;
identification information of an AI platform configured to indicate an AI platform supported by the UE;
AI inference indication information configured to indicate whether the UE supports an AI inference capability;
AI training indication information configured to indicate whether the UE supports a training capability of the AI model.

In some embodiments, UE can be various mobile terminals or fixed terminals. For example, the UE can be, but is not limited to, a mobile phone, a computer, a server, a wearable device, an on-board terminal, a road side unit (RSU), a game control platform, or a multimedia device, etc.

In some embodiments, the step S21 can include sending the AI capability information of the UE to the base station.

In some embodiments, the base station can be of various types. For example, the base station can be a 2G base station, a 3G base station, a 4G base station, a 5G base station, or other evolved base stations.

In some embodiments, the step S21 can include sending the AI capability information to a network device.

In some embodiments, the network device can be an access network device or a core network device. The access network device can be various base stations. The core network device can be various logical nodes or functions of the core network. For example, the core network device can be the Access and Mobility Management Function (AMF) or the Network Function (NF). In some embodiments, UE sending its AI capability information to the network device can include that the UE sends the AI capability information of the UE to the base station, and the base station forwards the AI capability information of the UE to the core network device.

In some embodiments, the step S21 can include reporting the AI capability information of the UE. For example, the UE reports the AI capability information of the UE to the base station.

In some embodiments, the AI capability indication information, the AI level indication information, the identification information of the AI model, the identification information of the AI platform, the AI inference indication information, and the AI training indication information can be respectively carried or indicated by at least one bit of the AI capability information.

In some embodiments, the AI capability information includes but is not limited to at least one of the following:
AI capability indication information configured to indicate whether a chip of the UE supports an AI capability;
AI level indication information configured to indicate a level of the AI capability supported by the chip of the UE.

In some embodiments, when the AI capability information indication takes a first value, such as “0”, it indicates that the UE supports the AI capability, and when the AI capability information indication takes a second value, such as “1”, it indicates that the UE does not support the AI capability.

In some embodiments, the AI capability can refer to any type of AI capability. In some embodiments, the AI capability can be, but is not limited to, the AI based CSI compression capability, or the AI positioning capability, etc.

In some embodiments, the level of the AI capability can be, but is not limited to, at least one of levels or series x, y, and z. In some embodiments, it is specified in the protocol that the AI capability supported by the chip of the UE can be classified into three levels, namely levels x, y, and z. In some embodiments, the base station and the UE negotiate that the AI capability supported by the chip of the UE can be classified into three levels, namely levels x, y, and z. In some embodiments, the three levels x, y, and z correspond to different computing capabilities and/or storage capabilities of the UE, respectively. In this way, it can be determined, based on the computing capacity and/or storage capacity of the UE, that to which level of the levels x, y, and z the AI capability supported by the UE belongs.

In some embodiments, different values of the AI level indication information can be used to indicate the level of the AI capability supported by the UE or by the chip of the UE.

In some embodiments, the AI model can be any type of AI model. In some embodiments, the AI model can be, but is not limited to, a CNN model, an RNN model, or a transformer model, etc.

In some embodiments, the identification information of the AI model is used to uniquely identify the AI model. In some embodiments, the UE can report the AI model indication information to inform the base station of the AI model supported by the UE, which is conducive to determining the AI model used by the UE by the base station.

In some embodiments, the AI platform can be any type of AI platform. In some embodiments, the AI platform can be, but is not limited to, a TensorFlow platform, or a Pytorch platform, etc.

In some embodiments, when the AI inference indication information takes a first value, such as “0”, it indicates that the UE supports the AI inference capability, and when the AI inference indication information takes a second value, such as “1”, it indicates that the UE does not support the AI inference capability.

In some embodiments, when the AI training indication information takes a first value, such as “0”, it indicates that the UE supports the training capability of the AI model, and when the AI training indication information takes a second value, such as “1”, it indicates that the UE does not support the training capability of the AI model.

In some embodiments, the AI capability information can be used to indicate the AI platform used by the AI model, and/or, the AI capability information can be used to indicate the AI platform corresponding to the supported by the UE or the chip of the UE. In some embodiments, the AI capability information can also be used by the base station to determine the AI platform corresponding to the AI model when the UE supports different AI models, and/or to determine the AI platform corresponding to the level of the AI capability when the UE or the chip of the UE supports different AI capability levels.

In this way, it can ensure that the same AI platform is used for the CSI compression by the UE and the CSI decompression by the base station.

In some embodiments, the AI capability information can be used by the base station to determine the AI model for the CSI compression used by the UE, and/or, the AI capability information can also be used by the base station to determine the AI model for the CSI decompression used by the base station.

According to embodiments of the present disclosure, the UE sends the AI capability information of the UE. The AI capability information is used by the base station to determine the AI model for the CSI used by the UE. The AI capability information includes at least one of the AI capability indication information, the AI level indication information, the identification information of the AI model, the identification information of the AI platform, the AI inference indication information, or the AI training indication information. In this way, the base station can learn the AI model used by the UE for the CSI compression, so that the base station can also decompress, based on the determined AI model, the compressed CSI reported by the UE, thereby ensuring that the compressed CSI reported by the UE can be correctly decompressed. Moreover, since there is no need of interacting the AI model between the base station and the UE, the signaling required for the AI model interaction can be reduced and the power consumption of the UE and the base station can be lowered.

In some embodiments, the AI capability information is reported per UE or per feature. In some embodiments, the per-UE reporting means that the UE only needs to report the AI capability information once, regardless of how many frequency bands the UE supports. In some embodiments, the per-feature reporting means that the UE reports the AI capability information separately for each frequency band and each frequency band group.

In some embodiments, the AI capability information is reported in a non-mandatory manner or in a conditional mandatory manner.

In some embodiments, the AI capability information being reported in the non-mandatory manner means that the UE is forced to report the AI capability information about the AI capability when reporting a UE capability.

In some embodiments, the AI capability information being reported in the conditional mandatory manner means that in the case where the UE supports a specific AI capability, the UE needs to report the AI capability information corresponding to the AI capability supported by the UE.

In some embodiments, if the UE supports at least one of the following AI capabilities: the UE supporting for reporting of compressed CSI based on the AI model, the UE supporting for the AI based inference capability, or the UE supporting for the training capability of the AI model, then the UE reports the AI capability information corresponding to the at least one of the AI capabilities.

In this way, the AI capability information of the AI capability supported by the UE can be reported in the conditional mandatory manner.

It should be noted that those skilled in the art can understand that the methods provided in embodiments of the present disclosure can be performed separately or together with some methods in embodiments of the present disclosure or in the related art.

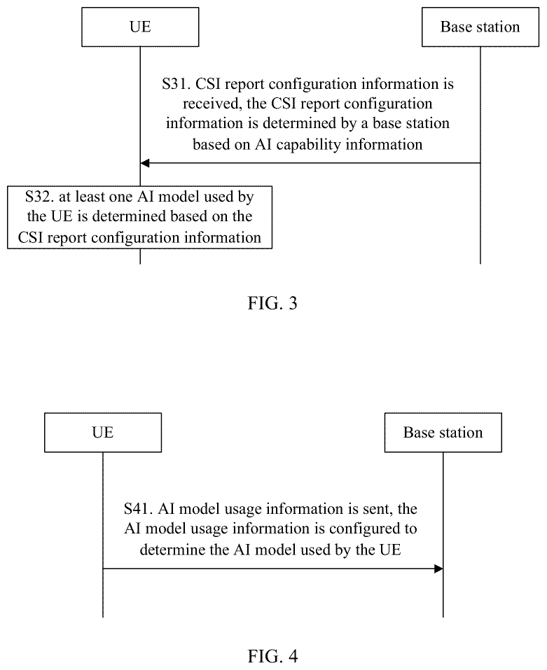

As shown in FIG. 3, embodiments of the present disclosure provide a method for determining an AI model. The method is performed by UE, and includes following steps.

In step S31, CSI report configuration information is received. In some embodiments, the CSI report configuration information is determined by a base station based on AI capability information.

In step S32, at least one AI model used by the UE is determined based on the CSI report configuration information.

In some embodiments of the present disclosure, the AI capability information can be the AI capability information described in step S21. The AI model can be the AI model described in step S21. In some embodiments, the AI capability information includes at least one of the AI capability indication information, the AI level indication information, the identification information of the AI model, the identification information of the AI platform, the AI inference indication information, or the AI training indication information.

In some embodiments, receiving the CSI report configuration information in step S31 can include receiving the CSI report configuration information sent by the base station.

In some embodiments, the CSI report configuration can be any type of CSI report configuration. In some embodiments, the CSI report configuration can be a periodic CSI report configuration or a non-periodic CSI report configuration. In some embodiments, the CSI report configuration can be a CSI report configuration based on a predetermined frequency band. In some embodiments, the CSI report configuration can be a CSI report configuration based on a certain Physical Uplink Shared Channel (PUCCH) resource. In some embodiments, the CSI report configuration can be a CSI report configuration based on a certain beam. More embodiments are not elaborated here.

In some embodiments, identification information of the CSI report configuration is used to uniquely identify the CSI report configuration. For example, when the identification information of the report configuration is “00”, the identification information of the CSI report configuration can be used to identify a specific CSI report configuration.

In some embodiments, step S32 includes: determining, in response to the identification information of the AI model being not included in the CSI report configuration information, to use an AI model supported by the UE, or determining, in response to identification information of at least one CSI report configuration and identification information of an AI model corresponding to the at least one CSI report configuration being included in the CSI report configuration information, to use a corresponding AI model for different CSI report configurations.

The method for determining the AI model provided in embodiments of the present disclosure can be performed by the UE. According to the method, if the CSI report configuration information does not include the identification information of the AI model, it is determined that the UE uses an AI model supported by the UE, alternatively, if the CSI report configuration information includes the identification information of at least one CSI report configuration and the identification information of the AI model corresponding to the at least one CSI report configuration, it is determined that the UE uses corresponding AI models for different CSI report configurations.

The method for determining the AI model provided in embodiments of the present disclosure can be performed by the UE. According to the method, it is determined, based on the identification information of the AI model included in the CSI report configuration information, that the UE uses the AI model indicated by the identification information of the AI model.

In some embodiments, the UE supports one AI model, and the UE receives the CSI report configuration information sent by the base station. If the UE determines that the CSI report configuration information does not include the identification information of the AI model, the UE then determines to use the one AI model supported by the UE.

In some embodiments, the UE supports one or more AI models, and the UE receives the CSI report configuration information sent by the base station. If the UE determines that the CSI report configuration information includes identification information of an AI model, the UE then determines to use the AI model indicated by the identification information of the AI model.

In some embodiments, the UE supports multiple AI models, and the UE receives the CSI report configuration information sent by the base station. The UE determines that the CSI report configuration information includes: identification information “00” of the CSI report configuration and identification information of a first AI model, as well as identification information “01” of the CSI report configuration and identification information of a second AI model. In some embodiments, if the UE determines to currently use the CSI report configuration indicated by the identification information “00” of the CSI report configuration, then the AI model used by the UE is the first AI model. In some embodiments, if the UE determines to currently use the CSI report configuration indicated by the identification information “01” of the CSI report configuration, then the AI model used by the UE is the second AI model.

According to embodiments of the present disclosure, the UE can accurately determine that the AI model for the CSI compression used by the UE, which corresponds to the AI model for the CSI decompression used by the base station, through receiving of the CSI report configuration information sent by the base station. In this way, it is possible to ensure that corresponding AI models can be used between the UE and the base station without the need for the UE and the base station to interact with specific AI parameter information of the AI model.

In some embodiments, the AI model used by the base station can correspond to the AI model used by the UE. The UE uses an AI compression model to compress CSI and sends the compressed CSI to the base station. The base station uses an AI decompression model corresponding to the UE to decompress the compressed CSI.

As shown in FIG. 4, embodiments of the present disclosure provide a method for determining an AI model. The method is performed by UE, and includes following steps.

In step S41, AI model usage information is sent. In some embodiments, the AI model usage information is configured to determine the AI model used by the UE.

The method for determining the AI model provided in embodiments of the present disclosure can be performed by the UE. According to the method, the AI model usage information is sent after the AI capability information is sent.

In some embodiments, the AI model usage information is configured to indicate the AI model used by the UE.

In some embodiments, the AI model usage information can be used by the base station to determine the AI model used by the UE, and/or, the AI model usage information can be used by the base station to determine the AI model used by the base station.

In some embodiments, the AI model usage information can be used by the UE to determine the AI model used by the UE.

In some embodiments, the AI model usage information includes at least one of the following:
identification information of the AI model;
identification information of the CSI report configuration corresponding to the identification information of the AI model.

In some embodiments, the UE sends the AI model usage information to the base station, the AI model usage information includes identification information of the AI model, and the AI model usage information is configured to indicate the AI model used by the UE. In this way, the base station can be directly informed of the AI model used by the UE.

In some embodiments, the UE sends the AI model usage information to the base station, and the AI model usage information includes identification information of the CSI report configuration. After receiving the identification information of the CSI report configuration, the base station can determine the identification information of the AI model used by the UE, based on the received identification information of the CSI report configuration and the correspondence between the stored identification information of the AI model and the identification information of the CSI report configuration. In this way, the AI model used by the UE can also be determined based on the received identification information of the CSI report configuration.

According to embodiments of the present disclosure, the UE can report the AI model usage information. If the AI model usage information carries the identification information of the AI model, the base station can be directly informed of the AI model used by the UE. If the AI model usage information carries the identification information of the CSI report configuration, the base station can determine the identification information of the AI model based on the identification information of the CSI report configuration, which can also enable the base station to determine the AI model used by the UE. In this way, multiple ways are provided to inform the base station of the AI model used by the UE, which can be applicable to more application scenes.

The method for determining the AI model provided in embodiments of the present disclosure can be performed by the UE. In some embodiments, the AI model used by the UE is determined.

The method for determining the AI model provided in embodiments of the present disclosure can be performed by the UE. In some embodiments, the AI model used by the UE is determined based on a scene in which the UE is located.

The method for determining the AI model provided in embodiments of the present disclosure can be performed by the UE. In some embodiments, the method includes at least one of the following:
the AI model used by the UE is determined based on the AI capability information of the UE;
the AI model used by the UE is determined based on the AI model supported by the UE.

In some embodiments, if the UE supports one AI model, the AI model supported by the UE is determined as the AI model used by the UE. In some embodiments, if the UE supports multiple AI models, any one of the multiple AI models is determined as the AI model used by the UE. More embodiments are not elaborated here.

In some embodiments, determining the AI model used by the UE based on the scene in which the UE is located includes: determining, based on that the UE is located in a first speed scene and/or an urban scene, to use a first-level AI model, alternatively, determining, based on that the UE is located in a second speed scene and/or a rural scene, to use a second-level AI model. In some embodiments, the first speed is less than or equal to the second speed.

The method for determining the AI model provided in embodiments of the present disclosure can be performed by the UE. In some embodiments, if the UE is located in the first speed scene and/or the urban scene, it can be determined that the UE uses the first-level AI model. In some embodiments, if the UE is located in the second speed scene and/or the rural scene, it can be determined that the UE uses the second-level AI model. In some embodiments, the first speed is less than or equal to the second speed.

In some embodiments, as specified in the protocol or negotiated between the base station and the UE, the AI capability supported by the UE can be classified into a first level and a second level, or the AI capability supported by the UE can be classified into a first level to an N^{th} level, where N is an integer greater than 1. In some embodiments, the AI capability supported by the UE can be classified into levels x, y, and z, and different levels correspond to different computing capabilities and/or storage capabilities of the UE. For example, the AI capability supported by the UE is classified into a first level and a second level, the computing and/or storage capabilities corresponding to the first level are lower than the computing and/or storage capabilities corresponding to the second level.

According to embodiments of the present disclosure, the UE can select, based on the scene in which the UE is located, an appropriate AI model for the CSI compression, so that the base station can perform the CSI decompression based on the corresponding AI model when the AI model used by the UE is sent to the base station.

In some embodiments, sending the AI model usage information in step S41 includes: sending the AI model usage information in response to report request information being received from a network device. In some embodiments, the report request information is configured to request for the AI model used by the UE.

The method for determining the AI model provided in embodiments of the present disclosure can be performed by the UE. According to the method, based on that the report request information is received from the network device, the AI model usage information is sent. In some embodiments, the report request information is configured to request for the AI model used by the UE.

In some embodiments, the UE receives the report request information sent by the base station, and sends the identification information of the AI model and/or the identification information of the CSI report configuration corresponding to the identification information of the AI model. The report request information is configured to request for the AI model used by the UE.

According to embodiments of the present disclosure, the UE can be triggered by the base station. That is, the UE can receive the report request information sent by the base station, to report the AI model usage information, which can enable the base station to accurately determine the AI model used by the UE.

It should be noted that those skilled in the art can understand that the methods provided in embodiments of the present disclosure can be performed separately or together with some methods in embodiments of the present disclosure or in the related art.

The method for determining an AI model, which is performed by the base station, will be provided in the following. The description of the method is similar to the description of the method for determining the AI model, which is performed by the UE, mentioned in the above. Moreover, for the technical details not disclosed in embodiments of the methods for determining the AI model performed by the base station, reference can be made to the descriptions of the embodiments of the methods for determining the AI model performed by the UE, which will not be described in detail here.

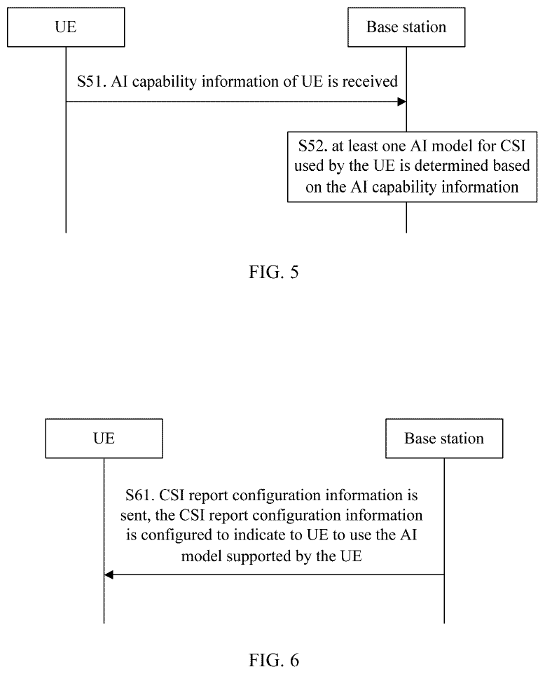

As shown in FIG. 5, embodiments of the present disclosure provide a method for determining an AI model. The method is performed by a base station, and includes following steps.

In step S51, AI capability information of UE is received.

In step S52, at least one AI model for CSI used by the UE is determined based on the AI capability information.

In some embodiments, the AI capability information includes at least one of the following: AI capability indication information configured to indicate whether the UE supports an AI capability;
AI level indication information configured to indicate a level of the AI capability supported by the UE;
identification information of an AI model configured to indicate an AI model supported by the UE;
identification information of an AI platform configured to indicate an AI platform supported by the UE;
AI inference indication information configured to indicate whether the UE supports an AI inference capability;
AI training indication information configured to indicate whether the UE supports a training capability of the AI model.

The methods for determining the AI model provided in embodiments of the present disclosure can also be performed by a network device. The network device can be a core network device.

In some embodiments of the present disclosure, the AI capability information can be the AI capability information described in step S21. The AI model can be the AI model described in the above embodiments.

In some embodiments, the step S51 can include receiving the AI capability information of the UE reported by the UE.

In some embodiments, the AI capability information includes but is not limited to at least one of the following:
AI capability indication information configured to indicate whether a chip of the UE supports an AI capability;
AI level indication information configured to indicate a level of the AI capability supported by the chip of the UE.

In some embodiments, the step S52 can include determining the at least one AI model for the CSI used by the UE, based on at least one of the AI capability indication information, the AI level indication information, the identification information of the AI model, the identification information of the AI platform, the AI inference indication information, or the AI training indication information.

In some embodiments, the base station receives the AI capability information sent by the UE. The AI capability information includes the AI capability indication information and the identification information of the AI model. If the base station determines that the AI capability indication information indicates that the UE supports the AI capability, then the base station can determine the AI model supported by the UE based on the identification information of the AI model. The base station selects one or more AI models from the AI models supported by the UE as the AI model(s) used by the UE.

In some embodiments, the base station receives the AI capability information sent by the UE. The AI capability information includes the AI capability indication information and the AI level indication information. If the base station determines that the AI capability indication information indicates that the UE supports the AI capability, then the base station can determine the level of the AI capability supported by the UE based on the AI level indication information. The base station determines that the AI model used by the UE is one or more AI models included in the level of AI capability.

In some embodiments, the base station receives the AI capability information sent by the UE. The AI capability information includes the identification information of the AI platform. The base station can determine the AI platform supported by the UE based on the identification information of the AI platform. The base station determines that the AI model used by the UE is one or more AI models corresponding to the AI platform supported by the UE.

According to embodiments of the present disclosure, the AI capability information sent by the UE can be used to determine an appropriate AI model for the UE to use. Moreover, the AI model used by the UE can be determined through various ways, which can be applicable to more application scenes.

More details of the methods in the above embodiments of the present disclosure can refer to the descriptions on the UE side, and will not be repeated here.

It should be noted that those skilled in the art can understand that the methods provided in embodiments of the present disclosure can be performed separately or together with some methods in embodiments of the present disclosure or in the related art.

As shown in FIG. 6, embodiments of the present disclosure provide a method for determining an AI model. The method is performed by a base station, and includes following steps.

In step S61, CSI report configuration information is sent. The CSI report configuration information is configured to indicate to UE to use the AI model supported by the UE.

In some embodiments of the present disclosure, the CSI report configuration information can be the CSI report configuration information described in step S31. The identification information of the CSI report configuration information can be the identification information of the CSI report configuration information described in the above embodiments.

In some embodiments, the CSI report configuration information is determined based on the AI capability information of the UE.

In some embodiments, sending the CSI report configuration information in step S61 includes determining, in response to determining that the UE supports one AI model, to send the CSI report configuration information that does not include identification information of the AI model. In some embodiments, the CSI report configuration information is configured to indicate to UE to use the one AI model supported by the UE.

The method for determining the AI model provided in embodiments of the present disclosure can be performed by the base station. According to the method, if the base station determines that the UE supports one AI model, the base station then determines to send the CSI report configuration information that does not include the identification information of the AI model. In some embodiments, the CSI report configuration information is configured to indicate to UE to use the one AI model supported by the UE.

In some embodiments, if the base station determines that the UE supports one AI model, the base station can also carry the identification information of the AI model in the CSI report configuration information.

In some embodiments, if the base station determines that the UE supports multiple AI models, the base station then selects one AI model from the multiple AI models and carries the identification information of this AI model in the CSI report configuration information to send to the UE.

According to embodiments of the present disclosure, the base station sends the CSI report configuration information to the UE to indicate that the CSI reported by the UE can be compressed using the AI model indicated to the UE by the base station.

In some embodiments, sending the CSI report configuration information in step S61 includes: sending the CSI report configuration information in response to determining that the UE supports multiple AI models, and the CSI report configuration information includes identification information of at least one CSI report configuration and identification information of the AI model corresponding to the at least one CSI report configuration.

The method for determining the AI model provided in embodiments of the present disclosure can be performed by the base station. According to the method, if the base station determines that the UE supports multiple AI models, the base station sends the CSI report configuration information including the identification information of at least one CSI report configuration and the identification information of the AI model corresponding to the at least one CSI report configuration.

In some embodiments, identification information of a CSI report configuration corresponds to identification information of an AI model.

In some embodiments of the present disclosure, the base station can configure multiple AI models for the UE to use, and configure different AI models for different CSI report configurations, so that the UE can use appropriate AI models to compress the CSI for different CSI report configurations.

More details of the methods in the above embodiments of the present disclosure can refer to the descriptions on the UE side, and will not be repeated here.

It should be noted that those skilled in the art can understand that the methods provided in embodiments of the present disclosure can be performed separately or together with some methods in embodiments of the present disclosure or in the related art.

The method for determining the AI model provided in embodiments of the present disclosure can be performed by the base station. The method includes: receiving AI model usage information sent by the UE, and determining the AI model for the CSI used by the base station based on the AI model usage information.

In some embodiments of the present disclosure, the AI model usage information can be the AI model usage information described in step S41.

In some embodiments, the AI model usage information includes at least one of the following:
identification information of the AI model;
identification information of the CSI report configuration corresponding to the identification information of the AI model.

The method for determining the AI model provided in embodiments of the present disclosure can be performed by the base station. The method includes sending report request information. In some embodiments, the report request information is configured to request for the AI model used by the UE.

In some embodiments, sending the report request information includes sending the report request information to the UE. The report request information is used to trigger the UE to report the AI model usage information.

More details of the methods in the above embodiments of the present disclosure can refer to the descriptions on the UE side, and will not be repeated here.

It should be noted that those skilled in the art can understand that the methods provided in embodiments of the present disclosure can be performed separately or together with some methods in embodiments of the present disclosure or in the related art.

To further explain any of embodiments of the present disclosure, a specific example is provided in the following.

Embodiments of the present disclosure provide a method for determining an AI model. The method can be performed by a communication device. The communication device includes the UE and the base station. The method for determining the AI model includes at least one of the following.

In step S71, the UE reports the AI capability information of the UE. In some embodiments, the AI capability information includes at least one of the following:
AI capability indication information configured to indicate whether the UE supports an AI capability;
AI level indication information configured to indicate a level of the AI capability supported by the UE;
identification information of an AI model configured to indicate an AI model supported by the UE;
identification information of an AI platform configured to indicate an AI platform supported by the UE;
AI inference indication information configured to indicate whether the UE supports an AI inference capability;
AI training indication information configured to indicate whether the UE supports a training capability of the AI model.

In some embodiments, the AI capability information is reported per UE or per feature.

In some embodiments, the AI capability information is reported in a non-mandatory manner or in a conditional mandatory manner. In some embodiments, if the UE supports at least one of the following AI capabilities: the UE supporting for reporting of compressed CSI based on the AI model, the UE supporting for the AI based inference capability, or the UE supporting for the training capability of the AI model, then the UE reports the AI capability information corresponding to the at least one of the AI capabilities.

In step S72, the base station receives the AI capability information and configures the AI model used by the UE. In some embodiments, the step S72 includes steps S72a and S72b.

In step S72a, the base station determines one or more AI models supported by the UE based on the AI capability information of the UE.

In step S72b, the base station determines the AI model used by the UE based on one or more AI models supported by the UE, and sends the CSI report configuration information.

In some embodiments, if the base station determines that the UE supports one AI model, the base station sends the CSI report configuration information that does not include the identification information of the AI model.

In some embodiments, if the base station determines that the UE supports multiple AI models, the base station sends the CSI report configuration information including the identification information of at least one CSI report configuration and the identification information of the AI model corresponding to the at least one CSI report configuration.

In some embodiments, the base station can indicate the AI model used by the UE based on the current channel state.

In some embodiments, the UE can compress the CSI based on the AI model configured by the base station, and the base station can use the corresponding AI model to decompress the compressed CSI.

In some embodiments, the step S72 can also be replaced by the step S73.

In step S73, the UE reports AI model usage information, and the AI model usage information is used to determine the AI model used by the UE.

In some embodiments, the UE determines the AI model used by the UE based on the scene in which the UE is located.

In some embodiments, based on that the UE is located in the first speed scene and/or the urban scene, the UE determines to use an AI model of a level x. In some embodiments, based on that the UE is located in the second speed scene and/or the rural scene, the UE determines to use an AI model of a level y. In some embodiments, the first speed is less than or equal to the second speed. In some embodiments, the computing and/or storage capabilities corresponding to the level x are lower than the computing and/or storage capabilities corresponding to the level y.

In some embodiments, the AI model usage information sent by the UE includes at least one of the following: identification information of the AI model, or identification information of the CSI report configuration corresponding to the identification information of the AI model.

In some embodiments, the AI model usage information can be actively reported by the UE or reported by the UE under triggering of the base station. In some embodiments, reporting by the UE under the triggering of the base station can include: reporting, by the UE, the AI model usage information, in response to receiving the report request information sent by the base station.

It should be noted that those skilled in the art can understand that the methods provided in embodiments of the present disclosure can be performed separately or together with some methods in embodiments of the present disclosure or in the related art.

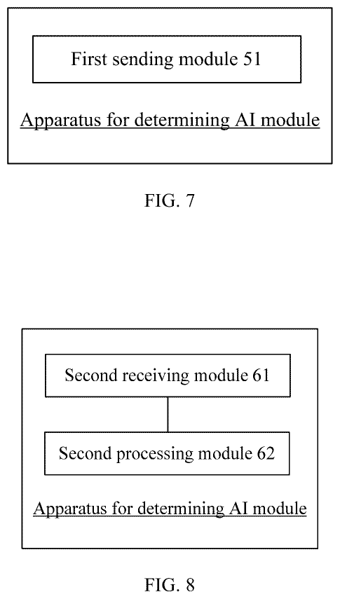

As shown in FIG. 7, embodiments of the present disclosure provide an apparatus for determining an AI model. The apparatus includes a first sending module 51.

The first sending module 51 is configured to send AI capability information of the UE, and the AI capability information is configured for a base station to determine an AI model for the CSI used by the UE. In some embodiments, the AI capability information includes at least one of the following:
AI capability indication information configured to indicate whether the UE supports an AI capability;
AI level indication information configured to indicate a level of the AI capability supported by the UE;
identification information of the AI model configured to indicate the AI model supported by the UE;
identification information of an AI platform configured to indicate the AI platform supported by the UE;
AI inference indication information configured to indicate whether the UE supports an AI inference capability; or
AI training indication information configured to indicate whether the UE supports a training capability of the AI model.

The apparatus for determining the AI model provided in embodiments of the present disclosure can be applied to the UE.

In some embodiments, the AI capability information is reported per UE.

In some embodiments, the AI capability information is reported in a non-mandatory manner or in a conditional mandatory manner.

Embodiments of the present disclosure provide an apparatus for determining an AI model. The apparatus includes a first receiving module and a first processing module.

The first receiving module is configured to receive CSI report configuration information. In some embodiments, the CSI report configuration information is determined by the base station based on the AI capability information.

The first processing module is configured to determine, based on the CSI report configuration information, at least one AI model used by the UE.

According to the apparatus for determining the AI model provided in embodiments of the present disclosure, the first processing module is configured to determine, in response to the identification information of the AI model being not included in the CSI report configuration information, to use the AI model supported by the UE.

According to the apparatus for determining the AI model provided in embodiments of the present disclosure, the first processing module is configured to determine, in response to identification information of at least one CSI report configuration and identification information of a corresponding AI model being included in the CSI report configuration information, to use the corresponding AI model for different CSI report configurations.

According to the apparatus for determining the AI model provided in embodiments of the present disclosure, the first sending module 51 is configured to send AI model usage information. In some embodiments, the AI model usage information is configured to determine the AI model used by the UE.

In some embodiments, the AI model usage information includes at least one of the following:
the identification information of the AI model; or
identification information of a CSI report configuration corresponding to the identification information of the AI model.

According to the apparatus for determining the AI model provided in embodiments of the present disclosure, the first sending module 51 is configured to send, in response to receiving report request information from a network device, the AI model usage information. The report request information is configured to request for the AI model used by the UE.

As shown in FIG. 8, embodiments of the present disclosure provide an apparatus for determining an AI model. The apparatus includes a second receiving module 61 and a second processing module 62.

The second receiving module 61 is configured to receive AI capability information of the UE.

The second processing module 62 is configured to determine, based on the AI capability information, at least one AI model for the CSI used by the UE.

In some embodiments, the AI capability information includes at least one of the following: AI capability indication information configured to indicate whether the UE supports an AI capability;
AI level indication information configured to indicate a level of the AI capability supported by the UE;
identification information of the AI model configured to indicate the AI model supported by the UE;
identification information of an AI platform configured to indicate the AI platform supported by the UE;
AI inference indication information configured to indicate whether the UE supports an AI inference capability; or
AI training indication information configured to indicate whether the UE supports a training capability of the AI model.

The apparatus for determining the AI model provided in embodiments of the present disclosure can be applied to the base station.

According to the apparatus for determining the AI model provided in embodiments of the present disclosure, a second sending module is included, and is configured to send CSI report configuration information, and the CSI report configuration information is configured to indicate to the UE to use the AI model indicated by the CSI report configuration information.

According to the apparatus for determining the AI model provided in embodiments of the present disclosure, the second sending module is configured to send, in response to determining that the UE supports one AI model, the CSI report configuration information not including the identification information of the AI model. The CSI report configuration information is configured to indicate to the UE to use the one AI model supported by the UE.

According to the apparatus for determining the AI model provided in embodiments of the present disclosure, the second sending module is configured to send, in response to determining that the UE supports multiple AI models, the CSI report configuration information including identification information of at least one CSI report configuration and identification information of a corresponding AI model.

According to the apparatus for determining the AI model provided in embodiments of the present disclosure, the second receiving module 61 is configured to receive the AI model usage information sent by the UE, and the second processing module 62 is configured to determine, based on the AI model usage information, the AI model for the CSI used by the base station.

In some embodiments, the AI model usage information includes at least one of the following:
the identification information of the AI model; or
identification information of a CSI report configuration corresponding to the identification information of the AI model.

According to the apparatus for determining the AI model provided in embodiments of the present disclosure, the second sending module is configured to send report request information. In some embodiments, the report request information is configured to request for the AI model used by the UE.

It should be noted that those skilled in the art can understand that the apparatus provided in embodiments of the present disclosure can be used separately or together with some apparatus in embodiments of the present disclosure or in the related art.

The specific ways in which each module of the apparatus provided in the above embodiments performs operations have been described in detail in the relevant method embodiments, and will not be elaborated here.

Embodiments of the present disclosure provide a communication device including a processor and a memory for storing executable instructions for the processor.

In some embodiments, the processor is configured to run the executable instructions to cause the method for determining the AI model described in any of the embodiments of the present disclosure to be implemented.

In some embodiments, the communication device can include, but is not limited to, at least one of the UE or the base station.

In some embodiments, the processor can include various types of storage media. The storage media are non-transitory computer storage media that can continue to remember and store information on the user equipment after the user equipment loses power.

The processor can be connected to the memory through a bus or other means for reading executable programs stored on the memory, such as for implementing at least one of the methods shown in FIGS. 2 to 6.

Embodiments of the present disclosure also provide a computer storage medium, which stores a computer executable program. When the computer executable program is executed by a processor, the method for determining the AI model described in any of the embodiments of the present disclosure is caused to be implemented, for example, at least one of the methods shown in FIGS. 2 to 6.

Regarding the devices or the storage media in the above embodiments, the specific ways in which each module performs operations have been described in detail in the relevant method embodiments, and will not be elaborated here.

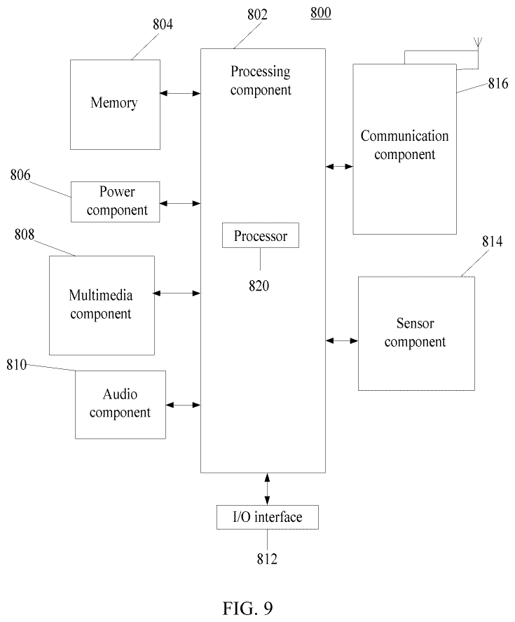

FIG. 9 is a block diagram of user equipment 800 according to embodiments of the present disclosure. For example, the user equipment 800 can be a mobile phone, a computer, a digital broadcasting user device, a messaging device, a game console, a tablet device, a medical device, a fitness device, a personal digital assistant, etc.

Referring to FIG. 9, the user equipment 800 can include at least one of the following components: a processing component 802, a memory 804, a power component 806, a multimedia component 808, an audio component 810, an input/output (I/O) interface 812, a sensor component 814, and a communication component 816.

The processing component 802 typically controls the overall operation of the user equipment 800, such as operations associated with display, telephone call, data communication, camera operation, and recording operations. The processing component 802 may include one or more processors to execute instructions to complete all or part of the methods described above. In addition, the processing component 802 may include one or more modules to facilitate interactions between the processing component 802 and other components. For example, the processing component 802 may include a multimedia module to facilitate the interaction between the multimedia component 808 and the processing component 802.

The memory 804 is configured to store various types of data to support operations on the user equipment 800. Examples of such data include instructions, contact data, phone book data, messages, pictures, videos, and the like for any application or method operating on the user equipment 800. The memory 804 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 806 provides power for various components of the user equipment 800. The power component 806 can include a power management system, one or more power supplies, and other components associated with generating, managing, and distributing power for the user equipment 800.

The multimedia component 808 includes a display screen providing an output interface between the user equipment 800 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 808 includes a front camera and/or a rear camera. When the user equipment 800 is in operation mode, such as shooting mode or video mode, the front camera and/or rear camera can receive external multimedia data. Each front camera and rear camera can be a fixed optical lens system or have focal length and optical zoom capability.

The audio component 810 is configured to output and/or input audio signals. For example, the audio component 810 includes a microphone (MIC), which is configured to receive an external audio signal when the user equipment 800 is in an operation mode, such as a calling mode, a recording mode, and a voice recognition mode. The received audio signal may be further stored in memory 804 or transmitted via communication component 816. In some embodiments, the audio component 810 also includes a speaker for outputting audio signals.

The I/O interface 812 provides an interface between the processing component 802 and peripheral interface modules, which can be a keyboard, click wheel, button, etc. These buttons may include, but are not limited to, the Home button, Volume button, Start button, and Lock button.

The sensor component 814 includes one or more sensors for providing various aspects of condition evaluation for the user equipment 800. For example, the sensor component 814 can detect an open/closed state of the user equipment 800, relative positioning of the components. The component is, for example, a display and a keypad of the user equipment 800. The sensor component 814 can also detect changes in the position of the user equipment 800 or one component of the user equipment 800, presence or absence of the user's contact with the user equipment 800, orientation or acceleration/deceleration of the user equipment 800 and temperature change of the user equipment 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the user equipment 800 and other devices. The user equipment 800 can access wireless networks based on communication standards, such as WiFi, 4G or 5G, or a combination thereof. In some embodiments, the communication component 816 receives a broadcast signal or broadcast related information from an external broadcast management system via a broadcast channel. In some embodiments, the communication component 816 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the user equipment 800 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 804 including instructions, which can be executed by the processor 820 of the user equipment 800 to complete above methods. For example, the non-transitory computer-readable storage medium can be ROM, random access memory (RAM), CD-ROM, tapes, floppy disks, optical data storage devices, etc.

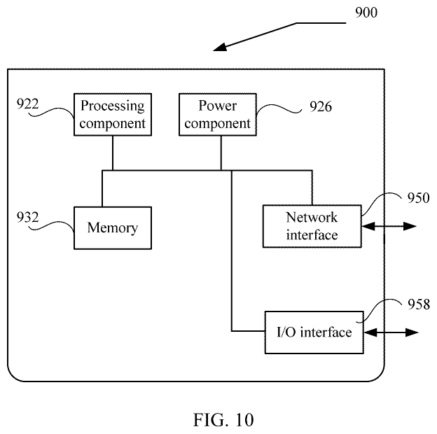

As shown in FIG. 10, embodiments of the present disclosure provide a structure of a base station. In some embodiments, the base station 900 can be provided as a network-side device. As shown in FIG. 10, the base station 900 includes a processing component 922, which further includes one or more processors, as well as memory resources represented by the memory 932, for storing instructions that can be executed by the processing component 922, such as application programs. The application program stored in the memory 932 can include one or more modules each corresponding to a set of instructions. In addition, the processing component 922 is configured to execute instructions to perform any of the methods previously applied to the base station.

The base station 900 can also include a power component 926 configured to perform power management for the base station 900, a wired or wireless network interface 950 configured to connect the base station 900 to the network, and an input/output (I/O) interface 958. The base station 900 can operate operating systems stored on memory 932, such as Windows Server TM, Mac OS X™, Unix™, Linux™, FreeBSD™, or similar.

After considering the specification and practices of the invention disclosed herein, those skilled in the art will easily come up with other implementation solutions of the present disclosure. The present disclosure intends to cover any variations, uses, or adaptive changes of the present disclosure, which follow the general principles of the present disclosure and include common knowledge or commonly used technical means in the art that are not disclosed in the present disclosure. The specification and embodiments are only considered as exemplary, and the true scope and spirit of the present disclosure are defined by appended claims.

It should be understood that embodiments of the present disclosure are not limited to the precise structure described in the above and shown in the drawings, and various modifications and changes can be made without departing from its scope. The scope of the present disclosure is limited only by the appended claims.

1. A method for determining an Artificial Intelligence (AI) model, performed by user equipment (UE), the method comprising:
sending AI capability information of the UE, wherein the AI capability information is configured for a base station to determine an AI model for Channel State Information (CSI) used by the UE, and wherein the AI capability information comprises at least one of:
AI capability indication information configured to indicate whether the UE supports an AI capability;
AI level indication information configured to indicate a level of the AI capability supported by the UE;
identification information of the AI model configured to indicate the AI model supported by the UE;
identification information of an AI platform configured to indicate the AI platform supported by the UE;
AI inference indication information configured to indicate whether the UE supports an AI inference capability; or
AI training indication information configured to indicate whether the UE supports a training capability of the AI model.

2. The method according to claim 1, wherein the AI capability information is sent per UE.

3. The method according to claim 1, wherein the AI capability information comprises non-mandatory information or conditional mandatory information.

4. The method according to claim 1, further comprising:
receiving CSI report configuration information, wherein the CSI report configuration information is determined by the base station based on the AI capability information; and
determining, based on the CSI report configuration information, at least one AI model used by the UE.

5. The method according to claim 4, wherein determining, based on the CSI report configuration information, the at least one AI model used by the UE, comprises one of:
determining, in response to the identification information of the AI model being not comprised in the CSI report configuration information, to use the AI model supported by the UE; and
determining, in response to identification information of at least one CSI report configuration and identification information of a corresponding AI model associated with the at least one CSI report configuration being comprised in the CSI report configuration information, to use the corresponding AI model for different CSI report configurations.

6. The method according to claim 4, further comprising:
sending AI model usage information, wherein the AI model usage information is configured to determine the AI model used by the UE.

7. The method according to claim 6, wherein the AI model usage information comprise at least one of:
the identification information of the AI model; or
identification information of a CSI report configuration corresponding to the identification information of the AI model.

8. The method according to claim 6, wherein sending the AI model usage information comprises:
sending, in response to receiving report request information from a network device, the AI model usage information, wherein the report request information is configured to request for the AI model used by the UE.

9. A method for determining an Artificial Intelligence (AI) model, performed by a base station, the method comprising:
receiving (AI capability information of user equipment (UE); and
determining, based on the AI capability information, at least one AI model for Channel State Information (CSI) used by the UE;
wherein the AI capability information comprises at least one of:
AI capability indication information configured to indicate whether the UE supports an AI capability;
AI level indication information configured to indicate a level of the AI capability supported by the UE;
identification information of the AI model configured to indicate the AI model supported by the UE;
identification information of an AI platform configured to indicate the AI platform supported by the UE;
AI inference indication information configured to indicate whether the UE supports an AI inference capability; or
AI training indication information configured to indicate whether the UE supports a training capability of the AI model.

10. The method according to claim 9, further comprising:
sending CSI report configuration information, wherein the CSI report configuration information is configured to indicate to the UE to use the AI model indicated by the CSI report configuration information.

11. The method according to claim 9, wherein sending the CSI report configuration information comprises:
sending, in response to determining that the UE supports one AI model, the CSI report configuration information not comprising the identification information of the AI model, wherein the CSI report configuration information is configured to indicate to the UE to use the one AI model supported by the UE.

12. The method according to claim 9, wherein sending the CSI report configuration information comprises:
sending, in response to determining that the UE supports multiple AI models, the CSI report configuration information comprising identification information of at least one CSI report configuration and identification information of a corresponding AI model associated with the at least one CSI report configuration.

13. The method according to claim 10, further comprising:
receiving AI model usage information sent by the UE; and
determining, based on the AI model usage information, the AI model for the CSI used by the base station.

14. The method according to claim 13, wherein the AI model usage information comprise at least one of:
the identification information of the AI model; or
identification information of a CSI report configuration corresponding to the identification information of the AI model.

15. The method according to claim 14, further comprising:
sending report request information, wherein the report request information is configured to request for the AI model used by the UE.

16-17. (canceled)

18. A user equipment (UE)communication device, comprising:
a processor; and
a memory for storing executable instructions for the processor;
wherein the processor is configured to run the executable instructions to cause the UE to perform method for determining the AI model according to claim 1.

19. A non-transitory computer storage medium having a computer executable program stored thereon, which when executed by a processor, causes the method for determining the AI model according to claim 1 to be implemented.

20. A base station, comprising:
a processor; and
a memory for storing executable instructions for the processor;
wherein the processor is configured to run the executable instructions to cause the base station to perform the method for determining the AI model according to claim 9.

21. A non-transitory computer storage medium having a computer executable program stored thereon, which when executed by a processor, causes the method for determining the AI model according to claim 9 to be implemented.
